(19) United States
(12) Patent Application Publication
(10) Pub. No.: US 2026/0339655 A1
(43) Pub. Date: Oct. 29, 2026

(54) SYSTEM AND METHOD FOR ECU VEHICLE CALIBRATION

(71) Applicant: TOYOTA JIDOSHA KABUSHIKI KAISHA, Toyota-shi (JP)

(72) Inventor: Maxence Delattre, Tokyo (JP)

(73) Assignee: TOYOTA JIDOSHA KABUSHIKI KAISHA, Toyota-shi (JP)

(21) Appl. No.: 19/191,026

(22) Filed: Apr. 28, 2025

(51) Int. Cl. G06F 8/71

(52) U.S. Cl. CPC G06F 8/71

(57) ABSTRACT

Provided are a method, system, and device for electronic control unit (ECU) calibration. The method may include receiving, by a ECU function, a first set of calibration parameters and corresponding operations; encoding, by the ECU function, the first set of calibration parameters and corresponding operations into an encoded message based on an ECU protocol; and sending, by the ECU function, the encoded message to an ECU, wherein the ECU is configured to: decode the encoded message to obtain a plurality of batches, each batch of the plurality of batches comprising a calibration parameter and corresponding operation of the first set of calibration parameters; and calibrate the ECU by executing each batch.

### FIELD

Example embodiments of the present disclosure relate to electronic control unit (ECU) vehicle calibration.

### BACKGROUND

In the related art, an electronic control unit (ECU) of a vehicle may have firmware or parameters configured therein for controlling a vehicle. To this end, an engineer or mechanic may intend to tune specific values, for example, parameters related to throttle control, by performing calibration on said ECU. For example, a user may send an encoded message to the ECU (e.g., in view of payload limitations, etc.), and the ECU may follow a procedure in order to decode the message to perform the calibration.

Systems in the related art may struggle with having to incorporate more than one type of parameters, in view that there is large parameter diversity based on differences in format, structure, and semantics, which thereby require specific knowledge on the operator in order to perform calibration. There may also be a lack of standardization in this regard.

Encoding and decoding of messages/payloads may also be provided/based solely on the user (delegated to the user using a delegation model), and thus, there is a high probability of errors attributed to the user. Related art systems may also struggle with large payload sizes, and may also be slow. Accordingly, there is a need for a more robust and efficient method for ECU calibration.

### SUMMARY

Example embodiments consistent with the present disclosure provide a method for electronic control unit (ECU) calibration. The method may include receiving, by a ECU function, a first set of calibration parameters and corresponding operations; encoding, by the ECU function, the first set of calibration parameters and corresponding operations into an encoded message based on an ECU protocol; and sending, by the ECU function, the encoded message to an ECU, wherein the ECU is configured to: decode the encoded message to obtain a plurality of batches, each batch of the plurality of batches comprising a calibration parameter and corresponding operation of the first set of calibration parameters; and calibrate the ECU by executing each batch

Based on the above, a more diverse set of parameters may be implemented. Further, since the payload can be larger than usual by including a list of batches, the overall speed of calibration may improve since the number of messages are reduced between the client device and the target ECU. Finally, since an architecture allows for the client device to be based on a user device which, for example, may implement a graphical user interface, a more user-friendly and less error-prone method for calibrating the data may be achieved.

According to example embodiments, the encoded write message may include a header and a payload including the first plurality of batches, wherein the header includes at least one version number of the ECU protocol, the type of operation, and a length of the first plurality of batches. The batch header of each batch may include a parameter identifier, a number of operations to be executed, and a list of operations, wherein each operation includes an offset value relative to a parameter base address, a length of the data, and the data to be written to the ECU.

According to example embodiments, the method may further include receiving, by the ECU function, a response based on whether the calibration was successful or not. The method may also include receiving, by the ECU function, a second set of parameters; encoding, by the ECU function, the second set of calibration parameters into an encoded read message based on the ECU protocol; sending, by the ECU function, the encoded read message to the ECU, wherein the ECU is configured to: decode the encoded read message to obtain a second plurality of batches, each batch of the second plurality of batches comprising a plurality of operations corresponding to the second set of parameters, and read the ECU based on the plurality of operations to obtain requested parameter data corresponding to the second set of parameters; and receiving, by the ECU function, the requested parameter data. Each operation of the plurality of operation may include an offset value relative to a parameter base address, and a length of the requested parameter data. The first set of calibration parameters and corresponding operations may be obtained from a user device.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like reference numerals denote like elements, and wherein:

FIG. 1 illustrates a block diagram of an example physical system architecture for ECU calibration according to one or more example embodiments;

FIG. 2 illustrates a block diagram of an example logical system architecture for ECU calibration, according to one or more example embodiments;

FIG. 3 illustrates an example message format and payload for ECU calibration, according to one or more example embodiments;

FIG. 4 illustrates a callflow diagram for sending a message payload to an ECU for calibration, according to one or more example embodiments;

FIG. 5 illustrates a callflow diagram for reading parameters from an ECU, according to one or more example embodiments;

FIG. 6 illustrates an example method for ECU calibration according to one or more example embodiments; and

FIG. 7 illustrates a diagram of an example components of a system that may be configured to implement one or more example embodiments.

### DETAILED DESCRIPTION

The following detailed description of exemplary embodiments refers to the accompanying drawings. The foregoing disclosure provides illustration and description but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “[A] and/or [B]”, “at least one of [A] and [B]” or “at least one of [A] or [B]” are to be understood as including only A, only B, or both A and B.

Expressions such as “at least one processor,” where configured to implement a plurality of operations, execute a plurality of instructions, etc., are to be understood as a single processor implementing the plurality of operations, etc., or each of plural processors implementing at least some (but not necessarily all) of the plurality of operations, etc.

Reference throughout this specification to “one embodiment,” “an embodiment,” “non-limiting exemplary embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Further, the described features, advantages, and characteristics of the present disclosure may be combined in any suitable manner in one or more example embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

Furthermore, the term “vehicle” described herein refers to any suitable type of vehicle in which example embodiments of the present disclosure can be implemented. For instance, the “vehicle” may refer to a motorized vehicle such as a car, a truck, a bus, a motorcycle, or any other suitable type of automobile powered by an engine, motor, or other mechanical means. Alternatively or additionally, the “vehicle” described herein may refer to a bicycle, a skateboard, and any other suitable types of non-motorized vehicle, without departing from the scope of the present disclosure.

Example embodiments of the present disclosure provide a method for electronic control unit (ECU) calibration in a vehicle, the method may include receiving, by a ECU function, a first set of calibration parameters and corresponding operations; encoding, by the ECU function, the first set of calibration parameters and corresponding operations into an encoded message based on an ECU protocol; and sending, by the ECU function, the encoded message to an ECU, wherein the ECU is configured to: decode the encoded message to obtain a plurality of batches, each batch of the plurality of batches comprising a calibration parameter and corresponding operation of the first set of calibration parameters; and calibrate the ECU by executing each batch.

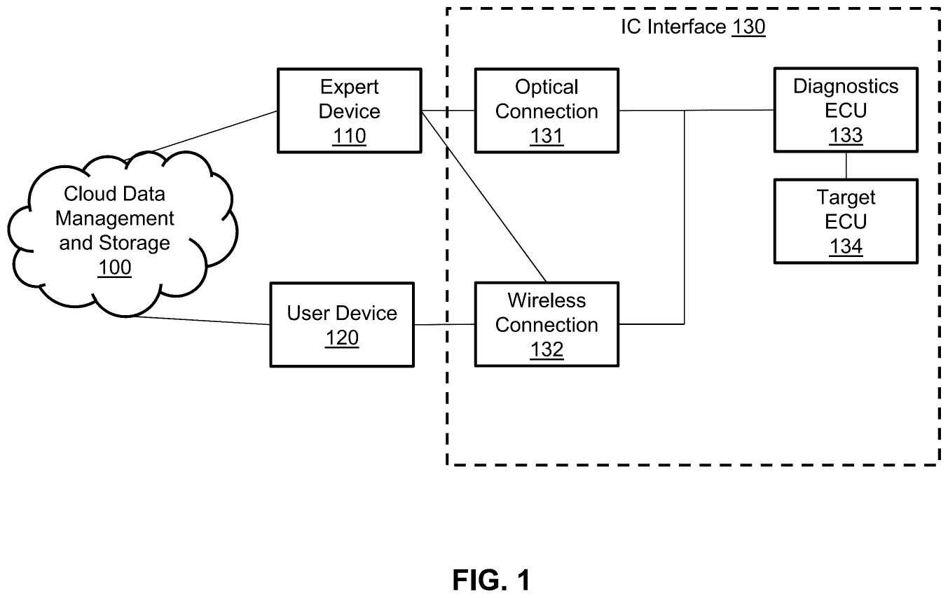

FIG. 1 illustrates a block diagram of an example physical system architecture for ECU calibration according to one or more example embodiments.

Cloud Data Management and Storage 100 (implementing for example a data management and storage service such as SPL), expert device 110, and user device 120 may be provided. Target ECU 134 may be implemented within an IC interface 130 (e.g., 32AT). IC interface 130 may include connection options such as optical connection 131 (e.g., OBD) and wireless connection 132 (e.g., 5G, Wifi, Bluetooth, etc.), and also include a diagnostics ECU 133 (such as using DCM protocol).

IC interface 130 and target ECU 134 may be connected to expert device 110 or a user device 120 via optical connection 131 or wireless connection 132. Specifically, expert device 110 (which may be a desktop/laptop computer, or some other computing device) may allow for more detailed configuration such as specifying parameters in coded form. Such coded form may either be in terms of data, or written as a function. Meanwhile, user device 120 may allow for a graphical user interface to specify the desired parameters for calibration in a more user-friendly format. Although a single expert device 110 and user device 120 are illustrated, it should be appreciated that configuration in which only expert device 110, or only user device 120 are provided are possible.

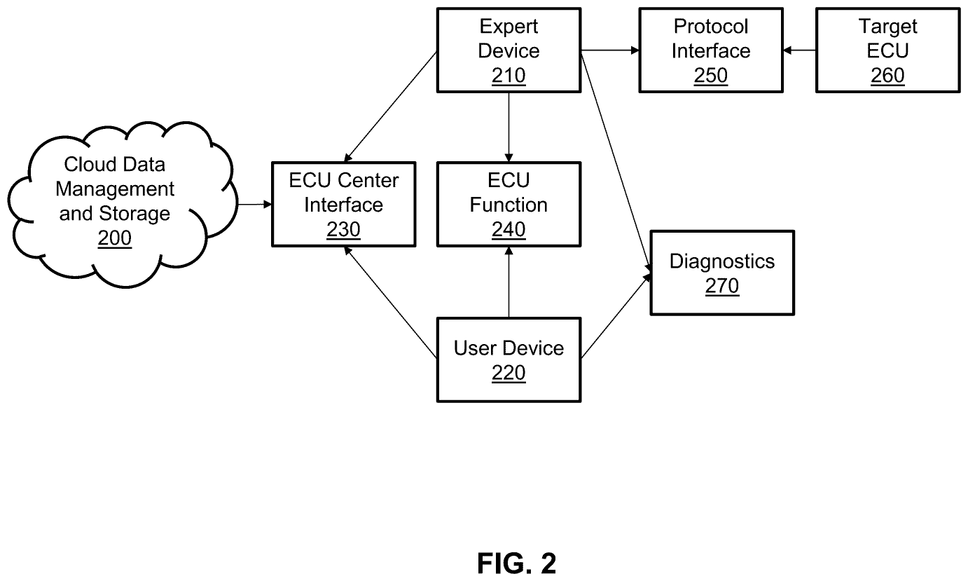

FIG. 2 illustrates a block diagram of an example logical system architecture for ECU calibration, according to one or more example embodiments.

Expert device 210 and user device 220 may implement an ECU function 240. Specifically, ECU function 240 may allow for expert device 210 and user device 220 to make some change to target ECU 260. Expert device 210 and user device 210 may also use ECU center interface 230, protocol interface 250, and diagnostics 270 (e.g., remote diagnostics).

Cloud data management and storage 200 may implement ECU center interface 230, which allows operations for calibration and measurement data management.

In order to support temporary calibration, target ECU 260 may implement a protocol interface 250, which may be used to decode the messages received. It may be assumed that, when using wireless communication, the vehicle provides an interface allowing running of Unified Diagnostic System (UDS) commands remotely. This is represented as diagnostics 270 in the diagram above. It should be appreciated that UDS is used as an example diagnostic system and other systems could be used.

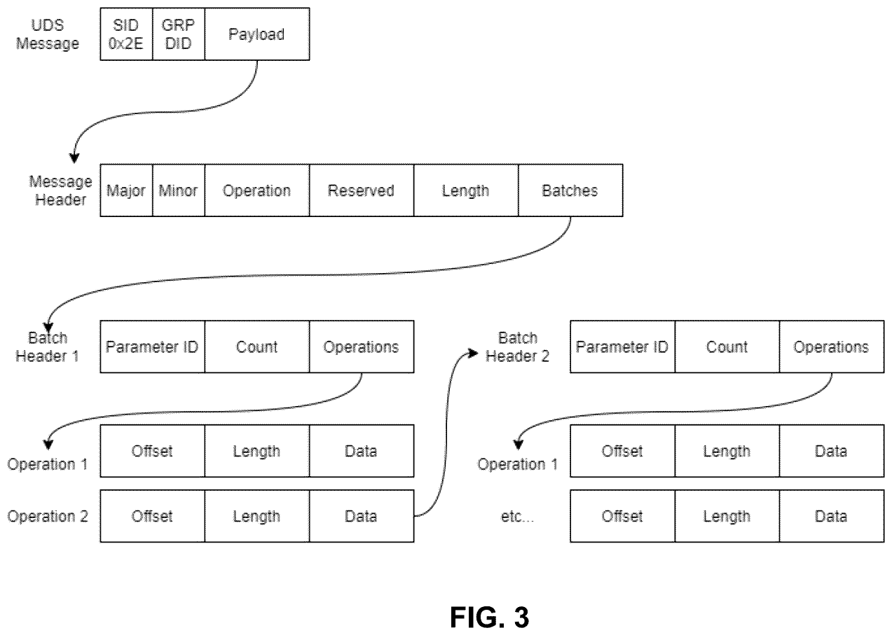

FIG. 3 illustrates an example message format and payload for ECU calibration, according to one or more example embodiments. In particular, an example message format which may be sent by the expert device/user device implementing the ECU function to the target ECU is shown.

The encoded message (exemplified as using an UDS message) may include ID's and a payload. The payload may include a message header, as well as a list of batches.

The message header may include the major/minor version numbers of the protocol being used, the type of operation (either read or write), the length of all the list of batches, and the list of the batches themselves.

The batch may comprise of a batch header which may specify a parameter ID (which corresponds to a parameter), a number of operations for this particular parameter ID, and a list of operations to be performed on the ID.

Depending on the specific type of operation (read/write), the format of each operation may vary.

For a write operation, the offset, the length of the data, and the data itself may be provided. The offset is relative to a parameter base address for the particular ID. For example, for a given throttle parameter, a base address of 5 (in decimal form) may be provided. The data to be written for several values could each have an example length of 10. Accordingly, the offset for each operation would be 5, 15, 25, . . . for a length of 10 in this example scenario.

The process for the write operation may include finding the parameter base address for the given parameter ID, computing the effective write address by adding the offset value, copying the data field to this address according to the length field, and repeating the previous steps according to the number of operations. If the total data processed is smaller than the header specified length, this is repeated until the total data equals the header length.

For a read operation, the format of the operation may only include the offset and the length. Similarly, if a given breaking threshold parameter has an example base address of 10, and data is given in an example length of 7, the offset may be 10, 17, 24, etc. for a uniform length of 7 in this example scenario.

The process executed by the ECU for the read operation may include finding the parameter base address for the given parameter ID, computing the effective read address by adding the offset value, and copying the data from this address to a buffer according to the length field, starting at the first free address. The buffer is therefore a concatenation of the successive read operations.

It can be appreciated that based on the above, a variety of parameter formats can be adopted using the same message protocol. Specifically, since the data does not necessarily need to have uniform length for each data point, a wider variety of parameters can be adopted, since the encoding/decoding can be delegated to a function thereby allowing multiple standards to be used.

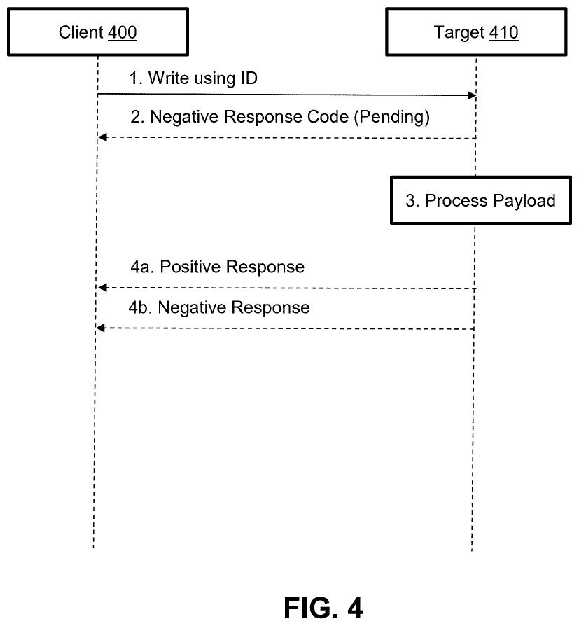

FIG. 4 illustrates a callflow diagram for sending a message payload to an ECU for calibration, according to one or more example embodiments. Client 400 may implement one of the user/expert devices illustrated in FIGS. 1 and 2 above, whereas target 410 refers to the target ECU.

At step 1, a write using id step is executed by client 400 and sent to target 410. This may be implemented, for example, by using UDS to send the message to the target 410, although it should be appreciated that other protocols may be used.

At step 2, upon successful validation of the message, the target 410 may receive a negative response code (pending) for example, 0x78 to indicate that the message was successfully received.

At step 3, the target 410 may process the payload. Since this is a write operation for calibration, it may include firstly decoding the message, then executing the process described with reference to FIG. 3 above by executing each batch and their corresponding operations to write data offset to the address of the parameter ID.

At step 4a, if a positive response is received, it indicates that the payload was successfully processed, and indicates to the client 400 that another message may be sent.

Otherwise, at step 4b, if a negative response is received, it indicates that the payload was not successfully processed in step 3, and this indicates to client 400 that some error has occurred. Roll-backs of the calibration operation, or an error message may be displayed to the user of client 400 accordingly.

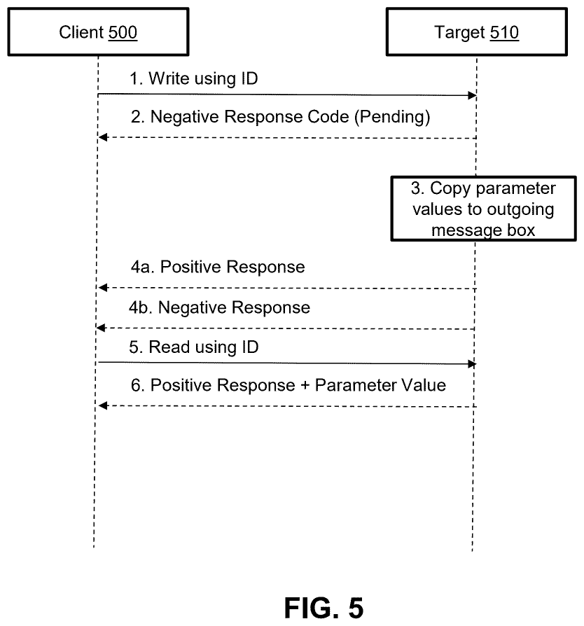

FIG. 5 illustrates a callflow diagram for reading parameters from an ECU, according to one or more example embodiments.

The similar steps 1, 2, 4a and 4b in FIG. 4 are included, and accordingly the description thereof is omitted. However, instead of executing a payload, in step 3, parameter values for each corresponding parameter ID are copied to an outgoing message box.

At step 5, a read message is sent to the target 510 from client 500 to read using ID. Based on the message, each operation from the batches may include reading from addresses in the ECU's memory based on offsets of the relevant parameter id, and providing those as a parameter value to the message box to be sent to the client 500.

At step 6, a positive response may also be included in order to indicate to client 500 that the data was read successfully.

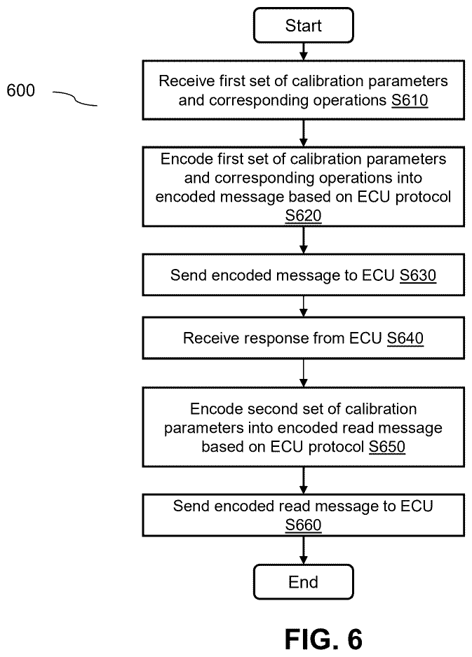

FIG. 6 illustrates an example method 600 for ECU calibration according to one or more example embodiments.

At operation S610, a first set of calibration parameters and corresponding operations may be received by an ECU function (e.g., ECU function 240 with reference to FIG. 2 above).

At operation S620, a first set of calibration parameters (and their corresponding operations) may be encoded into an encoded write message based on an ECU protocol.

At operation S630, the encoded message from operation S620 may be sent to the ECU. The ECU, upon receiving this encoded message, may be configured to decode the encoded message to obtain a plurality of batches, each batch containing a calibration parameter and corresponding operations from the first set of calibration parameters, and accordingly calibrate the ECU by executing each batch.

The encoded write message may include a header and a payload including the first plurality of batches, and the header may include at least one version number of the ECU protocol, the type of operation, and a length field of the first plurality of batches.

The Batch header of each batch may also include a parameter identifier, a number of operations to be executed, and a list of operations, each operation including an offset value relative to a parameter base address, a length of the data, and the data to be written to the ECU.

At operation S640, a response may be received from the ECU based on operation S630. A positive response may indicate that the calibration was successful, whereas a negative response may indicate that the operation was not successful.

At operation S650, a second set of calibration parameters may be encoded into an encoded read message based on the ECU protocol (it may be received by the ECU function)

At operation S660, the encoded read message from operation S650 may be sent to the ECU. In particular, upon receiving the encoded read message, the ECU may be configured to de4code the encoded read message to obtain a second plurality of batches, each batch comprising a plurality of operation s corresponding to the second set of parameters, and read the ECU based on the plurality of operations to obtain requested parameter data corresponding to the second set of parameters, and receive the requested parameter data accordingly.

Each operation of the plurality of operations in operation S660 may include an offset value relative to a parameter based address, and a length of the requested parameter data.

It should be appreciated that the first set of calibration parameters and corresponding operations may be obtained from a user device or an expert device (as described with reference to FIGS. 1 and 2 above).

Example embodiments of the present disclosure can be understood based on the above, to allow a more diverse set of parameters may be implemented. Further, since the payload can be larger than usual by including a list of batches, the overall speed of calibration may improve since the number of messages are reduced between the client device and the target ECU. Finally, since an architecture allows for the client device to be based on a user device which, for example, may implement a graphical user interface, a more user-friendly and less error-prone method for calibrating the data may be achieved.

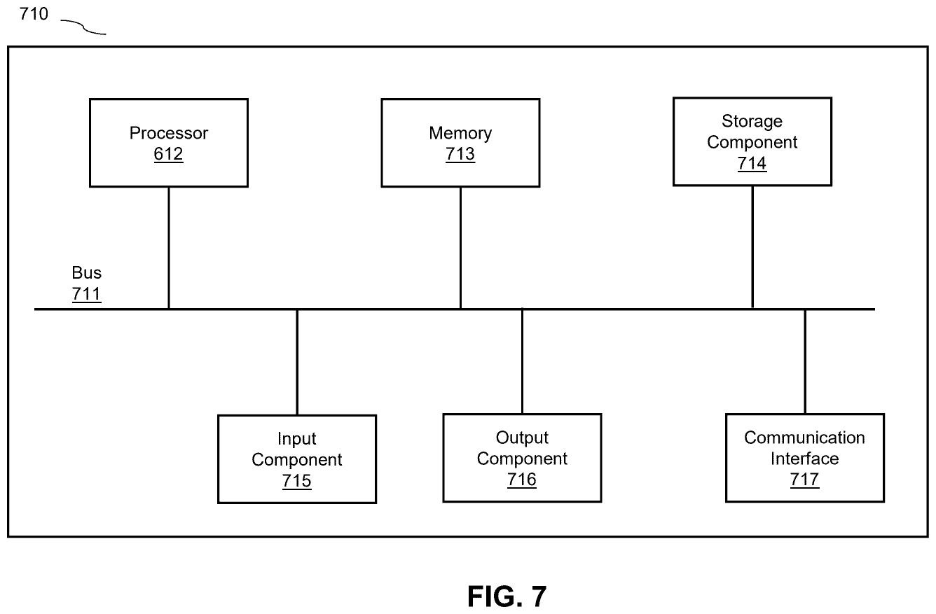

FIG. 7 illustrates a diagram of example components of a system, according to one or more example embodiments. As illustrated in FIG. 7, the system 710 may include at least one bus 711, at least one processor 712, at least one memory 713, at least one storage component 714, at least one input component 715, at least one output component 716, and at least one communication interface 717.

It is contemplated that the system 710 may include more or less components than illustrated in FIG. 7, without departing from the scope of the present disclosure. For instance, in some embodiments, the system 710 may include a plurality of storage components 714, the input component 715 and the output component 716 may be implemented as a transceiver component, the memory 713 and storage component 714 may be implemented as a memory storage, and the like.

The bus 711 may be configured to facilitate or enable communications among the components of the system 710. Specifically, the bus 711 may communicatively couple the components to each other and provide a means for data transfer and flow of control signals between the components. The bus 711 may include one or more of: an internal bus, an address bus, a data bus, a control bus, a controller area network (CAN) bus, an Ethernet bus, a peripheral component interconnect express (PCIe) bus, and any other suitable type of bus that can be implemented in the system 710 to enable communication and coordination between the components within the system 710 in real-time (or near real-time).

The processor 712 may be implemented in hardware, firmware, or a combination of hardware and software, and may be configured to handle real-time (or near real-time) data processing and control of the control system 710. The processor 712 may include one or more of: a central processing unit (CPU), a graphics processing unit (GPU), a neural processing unit (NPU), a tensor processing unit (TPU), an accelerated processing unit (APU), a microprocessor, a microcontroller, a digital signal processor (DSP), a field-programmable gate array (FPGA), an application-specific integrated circuit (ASIC), and/or another type of processing or computing component that can be implemented in the system 710. In some implementations, the processor 712 may be capable of being programmed to perform one or more operations described herein. Further, the processor 712 may include a plurality of processing units, each of which is dedicated to performing a specific operation.

The memory 713 may include one or more mediums for storing temporary data, runtime variables, program instructions, and buffers required for the operations of the control system 710. The memory 713 may include one or more of: a flash memory, a read-only memory (ROM), a random-access memory (RAM), a dynamic or static storage device (e.g., a flash memory, a magnetic memory, and/or an optical memory), any other suitable type of memory that can be implemented in the system 710 to store information and/or instructions for use by the processor 712.

The storage component 714 may be configured to store non-volatile data, such as firmware, configuration settings, calibration data, information, and/or software related to the operation and use of the system 710. For example, the storage component 714 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

According to embodiments, the storage component 714 may be configured to store computer-readable or computer-executable instructions for implementing one or more operations of the system 710. The storage component 714 may provide the stored information to the memory 713 for the execution of the processor 712.

The input component 715 may include one or more input components that permit the system 710 to receive information, such as via user input (e.g., a touch screen display, a keyboard, a keypad, a mouse, a button, a switch, and/or a microphone). The output component 716 may include one or more output components that provide output information from the system 710 (e.g., a display, a speaker, a navigation device, one or more light-emitting diodes (LEDs), etc.) According to embodiments, the input component 715 and/or the output component 716 may be optional and may be excluded from the system 710.

The at least one communication interface 717 may include a transceiver-like component (e.g., a transceiver and/or a separate receiver and transmitter) that enables the system 710 to communicate with other components (e.g., ECUs, user devices, etc.), such as via a wired connection, a wireless connection, or a combination of wired and wireless connections. For example, communication interface 717 may include a controller area network (CAN) bus interface, an Ethernet interface, an optical interface, a coaxial interface, an infrared interface, a radio frequency (RF) interface, a universal serial bus (USB) interface, a Wi-Fi interface, a cellular network interface, or the like.

According to one or more embodiments, the communication interface 717 may include at least one input/output (I/O) interface, at least one network interface, at least one storage interface, or the like, that enable the components 712-716 to communicate with other components. Further, the communication interface 717 may include one or more application programming interfaces (APIs) that allow the system 710 (or one or more components included therein) to communicate with one or more software applications (e.g., software application deployed in the ECUs, etc.)

Computer-executable instructions (e.g., software instructions, etc.) may be read into memory 713 and/or storage component 714 from another computer-readable medium or from another device (e.g., a remote server, an external storage, etc.) via, for example, the communication interface 717. When executed, the computer-executable instructions stored in memory 713 and/or storage component 714 may cause the processor 712 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

It is contemplated that features, advantages, and significances of example embodiments described hereinabove are merely a portion of the present disclosure, and are not intended to be exhaustive or to limit the scope of the present disclosure. Further descriptions of the features, components, configuration, operations, and implementations of example embodiments of the present disclosure, as well as the associated technical advantages and significances, are provided in the following.

It is understood that the specific order or hierarchy of blocks in the processes/ flowcharts disclosed herein is an illustration of example approaches. Based upon design preferences, it is understood that the specific order or hierarchy of blocks in the processes/ flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer-readable medium at any possible technical detail level of integration. Further, as described hereinabove, one or more of the above components described above may be implemented as instructions stored on a computer readable medium and executable by at least one processor (and/or may include at least one processor) . The computer-readable medium may include a computer-readable non-transitory storage medium (or media) having computer-readable program instructions thereon for causing a processor (or processors) to carry out operations.

The computer readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object-oriented programming languages such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a SoC, a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or another device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

What is claimed is:

1. A method for electronic control unit (ECU) calibration, the method comprising:
receiving, by a ECU function, a first set of calibration parameters and corresponding operations;
encoding, by the ECU function, the first set of calibration parameters and corresponding operations into an encoded message based on an ECU protocol; and
sending, by the ECU function, the encoded message to an ECU, wherein the ECU is configured to:
decode the encoded message to obtain a plurality of batches, each batch of the plurality of batches comprising a calibration parameter and corresponding operation of the first set of calibration parameters; and
calibrate the ECU by executing each batch.

2. The method as claimed in claim 1, wherein the encoded write message comprises a header and a payload including the first plurality of batches, wherein the header comprises:
at least one version number of the ECU protocol, the type of operation, and a length of the first plurality of batches.

3. The method as claimed in claim 2, wherein a batch header of each batch comprises a parameter identifier, a number of operations to be executed, and a list of operations, wherein each operation comprises an offset value relative to a parameter base address, a length of the data, and the data to be written to the ECU.

4. The method as claimed in claim 1, further comprising:
receiving, by the ECU function, a response based on whether the calibration was successful or not.

5. The method as claimed in claim 1, further comprising:
receiving, by the ECU function, a second set of parameters;
encoding, by the ECU function, the second set of calibration parameters into an encoded read message based on the ECU protocol;
sending, by the ECU function, the encoded read message to the ECU, wherein the ECU is configured to:
decode the encoded read message to obtain a second plurality of batches, each batch of the second plurality of batches comprising a plurality of operations corresponding to the second set of parameters, and
read the ECU based on the plurality of operations to obtain requested parameter data corresponding to the second set of parameters; and
receiving, by the ECU function, the requested parameter data.

6. The method as claimed in claim 5, wherein each operation of the plurality of operation comprises an offset value relative to a parameter base address, and a length of the requested parameter data.

7. The method as claimed in claim 1, wherein the first set of calibration parameters and corresponding operations are obtained from a user device.

8. An apparatus for electronic control unit (ECU) calibration, the apparatus configured to:
receive a first set of calibration parameters and corresponding operations;
encode the first set of calibration parameters and corresponding operations into an encoded message based on an ECU protocol; and
send the encoded message to an ECU, wherein the ECU is configured to:
decode the encoded message to obtain a plurality of batches, each batch of the plurality of batches comprising a calibration parameter and corresponding operation of the first set of calibration parameters; and
calibrate the ECU by executing each batch.

9. The apparatus as claimed in claim 8, wherein the encoded write message comprises a header and a payload including the first plurality of batches, wherein the header comprises:
at least one version number of the ECU protocol, the type of operation, and a length of the first plurality of batches.

10. The apparatus claimed in claim 9, wherein a batch header of each batch comprises a parameter identifier, a number of operations to be executed, and a list of operations, wherein each operation comprises an offset value relative to a parameter base address, a length of the data, and the data to be written to the ECU.

11. The apparatus as claimed in claim 8, further configured to:
receive a response based on whether the calibration was successful or not.

12. The apparatus as claimed in claim 8, further configured to:
receive a second set of parameters;
encode the second set of calibration parameters into an encoded read message based on the ECU protocol;
send the encoded read message to the ECU, wherein the ECU is configured to:
decode the encoded read message to obtain a second plurality of batches, each batch of the second plurality of batches comprising a plurality of operations corresponding to the second set of parameters, and
read the ECU based on the plurality of operations to obtain requested parameter data corresponding to the second set of parameters; and
receive the requested parameter data.

13. The apparatus as claimed in claim 12, wherein each operation of the plurality of operation comprises an offset value relative to a parameter base address, and a length of the requested parameter data.

14. The apparatus as claimed in claim 8, wherein the first set of calibration parameters and corresponding operations are obtained from a user device.

15. A non-transitory computer-readable recording medium having recorded thereon instructions to perform a method for electronic control unit (ECU) calibration, the method comprising:
receiving, by a ECU function, a first set of calibration parameters and corresponding operations;
encoding, by the ECU function, the first set of calibration parameters and corresponding operations into an encoded message based on an ECU protocol; and
sending, by the ECU function, the encoded message to an ECU, wherein the ECU is configured to:
decode the encoded message to obtain a plurality of batches, each batch of the plurality of batches comprising a calibration parameter and corresponding operation of the first set of calibration parameters; and
calibrate the ECU by executing each batch.

16. The non-transitory computer-readable recording medium as claimed in claim 15, wherein the encoded write message comprises a header and a payload including the first plurality of batches, wherein the header comprises:
at least one version number of the ECU protocol, the type of operation, and a length of the first plurality of batches.

17. The non-transitory computer-readable recording medium as claimed in claim 16, wherein a batch header of each batch comprises a parameter identifier, a number of operations to be executed, and a list of operations, wherein each operation comprises an offset value relative to a parameter base address, a length of the data, and the data to be written to the ECU.

18. The non-transitory computer-readable recording medium as claimed in claim 15, the method further comprising:
receiving, by the ECU function, a response based on whether the calibration was successful or not.

19. The non-transitory computer-readable recording medium as claimed in claim 15, the method further comprising:
receiving, by the ECU function, a second set of parameters;
encoding, by the ECU function, the second set of calibration parameters into an encoded read message based on the ECU protocol;
sending, by the ECU function, the encoded read message to the ECU, wherein the ECU is configured to:
decode the encoded read message to obtain a second plurality of batches, each batch of the second plurality of batches comprising a plurality of operations corresponding to the second set of parameters, and
read the ECU based on the plurality of operations to obtain requested parameter data corresponding to the second set of parameters; and
receiving, by the ECU function, the requested parameter data.

20. The non-transitory computer-readable recording medium as claimed in claim 19, wherein each operation of the plurality of operation comprises an offset value relative to a parameter base address, and a length of the requested parameter data.
